(19) United States
(12) Patent Application Publication
(10) Pub. No.: US 2005/0181328 A1
(43) Pub. Date: Aug. 18, 2005

(54) Ultrasonic scaler tip incorporating a depth gauge

(76) Inventor: Stephanie C. Milne, Provo, UT (US)

Correspondence Address: Angus C. Fox, III, 4093 N. Imperial Way, Provo, UT, 84604-5386, US

(21) Appl. No.: 10/779,066

(22) Filed: Feb. 17, 2004

(51) Int. Cl. A61C 3/03

(52) U.S. Cl. 433/119

(57) ABSTRACT

An ultrasonic scaler tip incorporating a multi-banded depth gauge allows a dental professional to more accurately judge the position of the tip with respect to the location of live tissue and alveolar bone. A typical cleaning operation would involve a two step process, with the depths of pockets being measured with a dental probe tip, the depths noted, and subsequently referred to during a cleaning of the teeth. The depth gauge is fabricated of durable coatings so as to be able to withstand the harsh conditions to which it will be repeatedly subjected. The banded scaler tip of the present invention may be fabricated in various ways. For a preferred embodiment, very thin bands of a dark-colored cylindrical bands are created on the tip. The entire tip is then covered by a transparent wear-resistant coating.

### BACKGROUND OF THE INVENTION

1. Field of the Invention

This invention relates generally to endodontic and periodontal ultrasonic dental scaler devices, and more specifically, to tips and inserts for those devices.

2. History of the Prior Art

It is important to preventive dentistry and healthy teeth that teeth be kept clean. Over time, various deposits can form on teeth. These deposits can form on the surface of a tooth below the gum line or in the periodontal pocket. Such deposits can take the form of calculus on the surface of teeth. Calculus is a solid material that bonds to the surface of teeth over a period of time. In order to maintain healthy teeth and gums, it should be removed periodically.

Many devices and methods have been developed over the years in attempts to better clean teeth. Early tools included manual picks and scrapers. However, within the last quarter century, a number of more sophisticated and effective tools have been developed. For example, U.S. Pat. No. 3,972,123 to Black, titled AIR-ABRASIVE PROPHYLAXIS EQUIPMENT, discloses a device for directing an air-abrasive stream or jet at teeth for the purpose of cleaning the surface thereof with insoluble abrasive particles. U.S. Pat. No. 3,956,826 to Perdreaux, Jr., titled ULTRASONIC DEVICE AND METHOD, discloses a hand held ultrasonic cleaning device used to clean teeth. Ultrasonic cleaning devices, or scalers as they are generally called, have since become the standard cleaning instrument for endodontic, periodontal and dental hygiene cleaning tasks.

Both sonic and ultrasonic power-driven scalers are available. Sonic scalers are typically air-turbine driven, operate at frequencies ranging between 3,000 and 8,000 herz, and are characterized by either linear or elliptical tip movement. Referring now to FIG. 1, a typical ultrasonic dental scaler 100 comprises a housing 101 which encloses a power supply, tuning circuitry, and a fluid pump, and is generally equipped with multiple controls 102 for operational parameter adjustment, a power cord 103 for connection to an AC power supply, a handpiece 104 which contains either a magnetostrictive or piezoelectric actuator for inducing high-speed vibratory motion, and which the dental professional grasps during cleaning operations, a scaler insert 105 that fits into the handpiece 104, a scaler tip 105 that is mechanically coupled to the actuator and which is used to shatter calcified deposits, a flexible cable 107 connecting the handpiece to the housing 101, a foot pedal 108 for controlling the vibratory intensity of the actuator, an electrical cable 109 connecting the foot pedal 108 to the housing 101, a hose 110 and a coupling 111 for connecting a fluid pump (not shown) in the housing 101 to a sterile water source (not shown), an optional reservoir 112 for holding medicinal fluid 113 used to irrigate cleaning sites, and a hose 114 which couples the reservoir 112 to the fluid pump in the housing 101. The flexible cable 107 includes both electrical conductors and a fluid supply hose (neither of which is visible). Two basic types of ultrasonic scalers are currently available: magnetostrictive and piezoelectric.

Magnetostrictive instruments typically operate within a frequency range of about 18,000 to 45,000 herz, and generally include a dental handpiece having an ultrasonic transducer positioned within an energizing coil located within a sleeve. As the upper threshold of human hearing is generally considered to be about 20,000 herz, the term “ultrasonic” is used somewhat loosely for those magnetrostrictive instruments below that frequency. The transducer or scaler insert conventionally comprises a stack of laminar plates of magnetostrictive material that is excited by the energizing coil to longitudinally expand and contract the transducer at an operational resonant frequency. Magnetostrictive materials transduce or convert magnetic energy to mechanical energy and vice versa. As a magnetostrictive material is magnetized, it strains; that is it exhibits a change in length per unit length. Conversely, if an external force produces a strain in a magnetostrictive material, the material's magnetic state will change. Magnetostriction is an inherent material property that does not degrade with time. To properly vibrate the dental scaler insert, the electronic circuit for the scaler unit generally includes an oscillating circuit having a variable output amplitude. In the case of a magnetostrictive scaler, the frequency of the oscillator is adjusted to the mechanical resonant frequency of the laminar plate stack of the scaler insert. This adjustment or tuning is generally accomplished either by a manually tuned circuit adjusted by the operator for optimum vibration or, in the alternative, automatically using a feedback coil in the handpiece coupled to associated control circuitry to electronically adjust the variable frequency oscillator to the correct output frequency. The feedback coil is generally formed by winding a wire near the base of the handpiece. The feedback coil is provided to register a voltage developed by the movement of the ultrasonic scaler insert within the electromagnetic field of the handpiece. Associated control circuitry uses this information to electronically adjust the variable frequency oscillator to the correct output frequency. The scaler insert typically includes an attached scaler tool having a scaler tip at the exposed end thereof. Tip movement of magnetostrictive scalers may be linear, elliptical, or circular, depending on the type of unit and shape and length of the tip. Magnetostrictive tip movement allows for activation of all surfaces of the tip simultaneously. Thus, any portion of the tip circumference may be applied to the surface of a tooth.

Piezoelectric units, on the other hand, represent a newer technology, and typically operate within a frequency range of about 25,000 to 50,000 herz. When a voltage is applied across a piezoelectric material, such as quartz (SiO₂) or certain ceramics, the crystal deforms. Conversely, when a piezoelectric material is deformed, an electric current is generated. When the voltage across the piezoelectric material is cut, the crystal assumes its original shape. By subjecting the material to either a pulsing DC signal or an alternating current signal, vibrational motion can be induced. Mechanical activation of the tip is generated by dimensional changes in crystals housed within the instrument handpiece. Various scaler tips may be attached to a free end of the handpiece. Because the resultant vibration is primarily linear in direction, only two sides of the tip can be active. Due to pressure variations, a signal from the handpiece is fed back to the main unit so that the main unit can track the variation of the pressure and adjust the intensity of the controlling signal accordingly. The feedback signal is a current induced by movement of the tip, and it is this induced signal that is fed back to the main unit to complete the control loop. An advantage to piezoelectric scalers is that they do not interfere with electronic heart pacemakers.

Both sonic and ultrasonic scalers generally incorporate a means for irrigating the area around the scaler tip by dispensing a liquid, such as water, through or over the surface of the scaler tip.

One of the problems associated with the use of ultrasonic dental scalers for certain endodontic and periodontic cleaning operations is that the tip of the scaler, the tissue being cleaned and the root surfaces are typically not visible. Although the ultrasonic vibrations enable a scaler tip to pulverize tarter and calculus that has become deposited on the surface of a tooth, those vibrations also enable the tip to slice through soft periodontal and endodontal tissue. As the ultrasonic vibrations do not distinguish between calculus and live tissue, it is essential that the scaler tip not be used to damage the latter. Thus, the use of an ultrasonic scaler for such applications requires a high degree of skill, proper selection of scaler tips and scaler power settings, as well as patience and vigilance to prevent damage to healthy and/or salvageable tissue. For example, a periodontic pocket has a fixed depth. When cleaning the surface of the tooth adjacent the pocket, it is essential that the dental professional not insert the scaler tip into tissue below the pocket, as that tissue will be damaged. It would be extremely useful if the dental professional could more precisely know the location of the scaler tip in relation to the location of the live tissue and alveolar bone.

Periodontal probes have been used for more than half a century to determine the health of the sulcus, the tissue that acts as a kind of fleshy collar around the gum, pocketing the teeth. The probe tip typically has a multi-banded depth gauge, or measurement scale that is typically calibrated in millimeters. Used to measure the depth of periodontal pockets, the probe tip is slipped into a periodontal pocket between the periodontal tissue and the vertical surface of a tooth. With the probe tip gently touching the bottom of the pocket, a measurement reading is taken. By taking periodic measurements and noting the depth for each tooth, the general health and condition of the gums can be ascertained. The depth of the pockets is indicative of the current state of health of the gums. As a general rule, the shallower the pocket, the healthier the sulcus. The rate at which the pockets increase in depth when measured on a periodic basis is indicative of the progress of gum disease.

Because tips of periodontal probes are not used as an abrasive tool, the depth gauges of such probes need not be particularly durable. In fact, they may even be painted on the tip. The probe tip is fabricated from surgical stainless steel and is generally cylindrically shaped. The dark bands are inset slightly from the light colored, plain stainless steel bands, so as to give the appearance of stainless steel cylinders of a first diameter alternatingly stacked with darker cylinders of a smaller second diameter. Presumably, the darker cylinders are inset to minimize the wear on the dark coating. Such an arrangement would be unacceptable for use on ultrasonic scalers, as the generally cylindrical surface over the entire length of the tip must be available for contacting the teeth of a patient during a scaling operation. The tips of scalers are, thus, subjected to an extremely harsh environment, with the sides of the scaler tips coming in contact with calcified calculus and the ultra-hard enamel of the teeth.

U.S. Pat. No. 5,236,358 to William J. Sieffert discloses an ultrasonic dental handpiece having a thin, flexible elongated abrasive tool attached thereto for removing calculus deposits form the surface of teeth. For a preferred embodiment of the invention, a distal portion of the tool is coated with diamond grit. The tool also incorporates an annular aperture, which surrounds the circumference of the abrasive tool, and through which a fluid spray is emitted for washing away loosened calculus. Because such an abrasive tool having diamond grit thereon can function much like a drill and remove tooth structure just as easily as it removes plaque, such a tool may be unsuited for standard periodontic cleaning procedures. In addition, though the patent application which resulted in the '358 patent was filed a dozen years ago, ultrasonic scalers having either straight tips or tips coated with a diamond abrasive do not appear to have not been adopted by the dental profession. Additionally, ultrasonic scaler tips used by the dental profession are, almost without exception, curved. It will be noted that the abrasive tool of the Sieffert device is equipped with a single depth gauge reference band located between the annular aperture and the abrasive distal portion. The positioning of this reference band is significant. Located on the uppermost portion of the tool, it is unlikely to be subjected to any abrasive action. Thus, the depth gauge reference band need not be particularly durable. In any case, the inventor makes no mention of how he intends to mark the band on the upper portion of the abrasive tool.

### SUMMARY OF THE INVENTION

The present invention provides an ultrasonic scaler tip with depth gauge or scale having an appearance similar to those found on dental probe tips. The addition of a dental probe-type depth scale to a dental scaler tip does not permit the scaler tip to be used as a probe during normal ultrasonic operation. However, it allows the operator to more accurately judge the position of the tip with respect to the location of tissue alveolar bone. A typical cleaning operation would involve a two step process, with the depth of pockets and/or root canals being measured with a dental probe tip and noted. Subsequent use of an ultrasonic scaler tip would take into account the depth measurements previously noted so as to avoid damage to the unseen tissue and alveolar bone. Whereas the banded depth gauge on a dental probe tip need not be particularly durable, the tip of an ultrasonic scaler tip must be able to withstand some 18,000 to 50,000 strokes per second against calcified deposits.

The banded scaler tip of the present invention may be fabricated in various ways. For a first embodiment of the invention, the stainless steel tip is machined so that the surfaces where the dark-colored cylindrical bands will be are recessed. A wear resistant material is then deposited over the surface of the entire tip to a depth that is at least the depth of the recessed, thereby filling the recessed surface areas. The wear-resistant material may be selected from the group which includes boron carbide (black), black amorphous diamond-like carbon, titanium nitride (gold), titanium aluminum nitride (brown), zirconium nitride (gold), tungsten carbide (grey) and silicon carbide (black). The wear-resistant material may be applied to the tip using physical vapor deposition, chemical vapor deposition or plasma spraying or other similar process that provides a dark and preferably black coating. The tip is then machined until the stainless steel of the tip is exposed on the surfaces adjacent the recessed areas. Optionally, a smooth transparent wear-resistant material, such as diamond-like carbon or aluminum oxide, may then be deposited over the entire tip, covering both the light-colored stainless steel bands and the dark-colored bands. Because it is nearly as hard as diamond, the diamond-like carbon coating is preferred. The transparent wear-resistant material coating ensures that all surfaces of the tip are uniformly hard so that any wear will occur evenly and without creating steps, as would occur if the band regions of stainless steel were to wear at a faster rate than the band regions of the wear-resistant material. For an alternative and preferred second embodiment of the invention, very thin bands of a dark, wear-resistant material are deposited on the tip. This may be done using a masking process or simply by depositing the material over a major portion of the entire tip and then selectively polishing the tip to leave the bands. Once the bands are formed, a transparent wear-resistant material is applied over the entire tip.

### BRIEF DESCRIPTION OF THE DRAWINGS (PHOTOGRAPHS)

FIG. 1 is a schematic diagram of a typical ultrasonic dental scaler system;

FIG. 2 is a side elevational view of a magnetostrictive scaler insert which incorporates a curved tip having an external upper fluid tube and a multi-banded depth gauge constructed in accordance with the present invention;

FIG. 3 is a side elevational view of a magnetostrictive scaler insert which incorporates a curved tip having a lower peripheral fluid orifice and a multi-banded depth gauge constructed in accordance with the present invention;

FIG. 4 is a side elevational view of scaler tool for a piezoelectric scaler, the tool incorporating a curved tip having an external upper fluid tube and a multi-banded depth gauge constructed in accordance with the present invention;

FIG. 5 is a side elevational view of scaler tool for a piezoelectric scaler, the tool incorporating a curved tip having a lower peripheral fluid orifice and a multi-banded depth gauge constructed in accordance with the present invention

FIG. 6 is a close-up view of a free end portion of a stainless steel scaler tip before the creation of a multi-banded depth gauge thereon;

FIG. 7 is a close-up view of the scaler tip portion of FIG. 6 following a machining operation which recesses the surface of the tip where the dark bands will be located;

FIG. 8 is a close-up view of the scaler tip portion of FIG. 7 after deposition of a dark-colored wear-resistant material layer;

FIG. 9 is a close-up view of the scaler tip portion of FIG. 8 after machining away a portion of the dark-colored wear-resistant material layer to expose stainless steel surfaces above and below each dark banded region;

FIG. 10 is a close-up view of the scaler tip portion of FIG. 9 following the deposition of a transparent wear-resistant layer over the surface of a major portion of the tip;

FIG. 11 is a close-up view of the scaler tip portion of FIG. 6 following the deposition of a thin dark-colored, wear-resistant material layer over a major portion of the tip;

FIG. 12 is a close-up view of the scaler tip portion of FIG. 11 following the selective polishing of the tip to leave a pair of cylindrical dark-colored bands thereon; and

FIG. 13 is a close-up view of the scaler tip portion of FIG. 12 after the deposition of a transparent wear-resistant material layer over a major portion thereof.

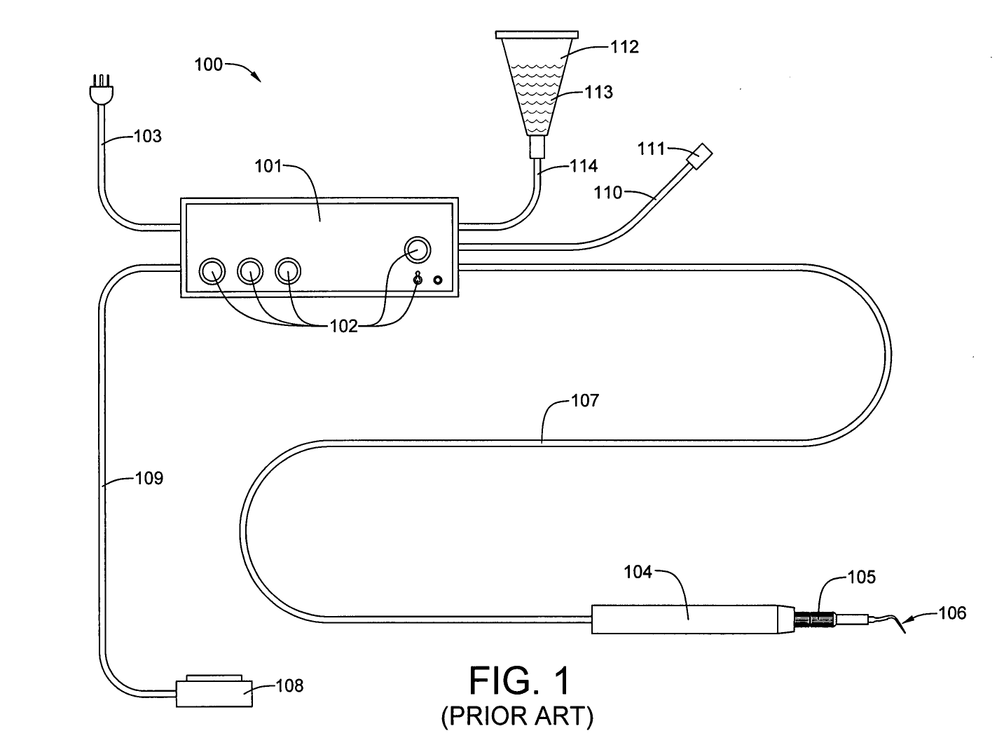

### DETAILED DISCLOSURE OF THE INVENTION

An ultrasonic scaler tip incorporating a multi-banded depth gauge allows a dental professional to more accurately judge the position of the tip with respect to the location of live tissue and alveolar bone during teeth cleaning operations. A typical cleaning operation would involve a two step process, with the depths of pockets being measured with a dental probe tip, the depths noted, and subsequently referred to during a cleaning of the teeth. It is assumed that the lack of depth gauges on available scaler tips is related to the difficulty in providing a depth gauge that will not be quickly abraded when it is repeatedly subjected to high-speed vibratory action at 18,000 to 50,000 strokes per second against calcified deposits. The banded scaler tip of the present invention may be fabricated using various processes, each of which is designed to provide a tip that has a durable multi-banded depth gauge and a curvilinear surface that is unlike the cylindrically-stepped surfaces typically employed on dental probes. The various types of scaler tips and the methods used to produce them will now be described with reference to the included drawing figures.

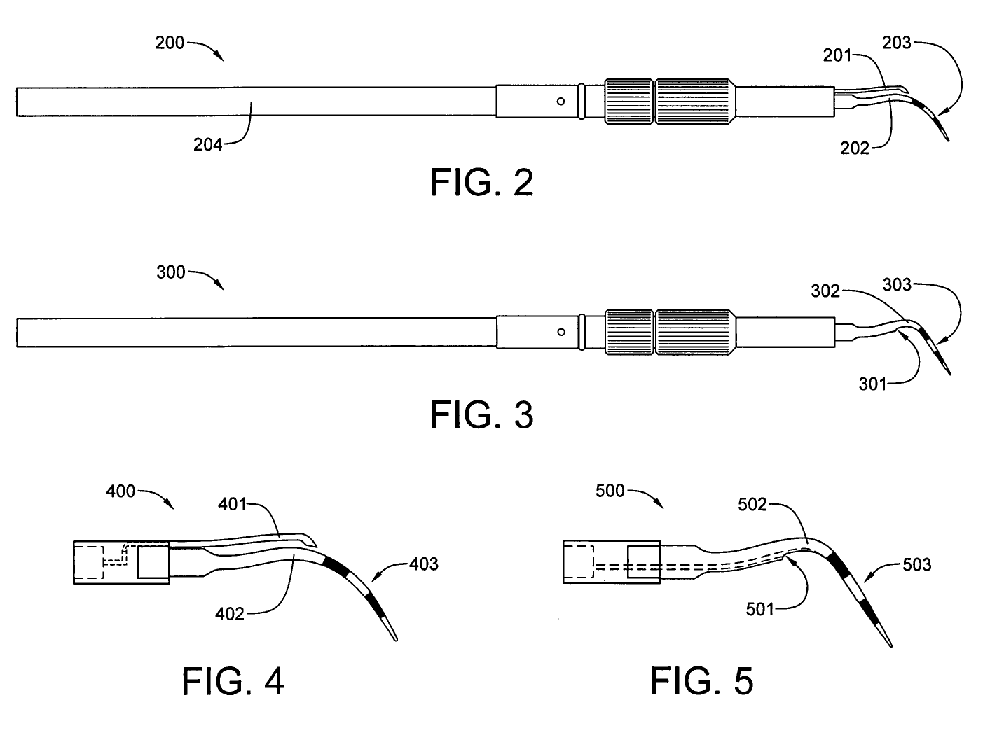

Referring now to FIG. 2, a first embodiment magnetostrictive scaler insert 200 having an external upper fluid tube 201, incorporates a curved scaler tip 202 having a multi-banded depth gauge 203 constructed in accordance with the present invention. As is typical of magnetostrictive scaler inserts, this one has an attached stack of laminations 204 which have been stamped from a magnetostrictive material. The stack 204 functions as a transducer by longitudinally expanding and contracting at an operational resonant frequency, when excited by the energizing coil in the handpiece.

Referring now to FIG. 3, a second embodiment magnetostrictive scaler 300 insert having a lower peripheral fluid orifice 301, incorporates an angled scaler tip 302 having a multi-banded depth gauge 303 constructed in accordance with the present invention.

Referring now to FIG. 4, a first embodiment scaler tool 400 for a piezoelectric scaler has an external upper fluid tube 401, and incorporates a curved scaler tip 402 having a multi-banded depth gauge 403 constructed in accordance with the present invention. The scaler tool 400 is desiged to attach directly to a piezoelectric transducer, which is incorporated in the handpiece.

Referring now to FIG. 5, a second embodiment scaler tool 500 for a piezoelectric scaler has a lower peripheral fluid orifice 501, and incorporates an angled scaler tip 502 that is equipped with a multi-banded depth gauge 503 constructed in accordance with the present invention.

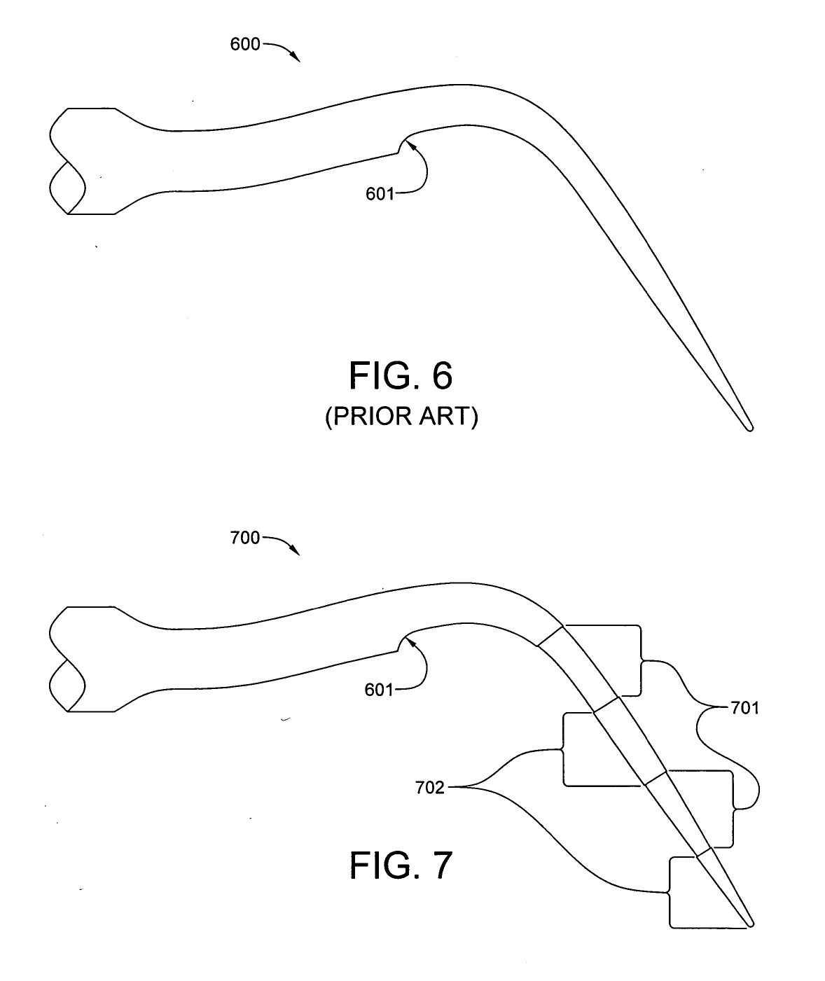

The multi-banded depth gauge, that is the focus of the present invention, may be applied to nearly any conventional scaler tip during the manufacturing process. Referring now to FIG. 6, a portion of a conventional stainless steel scaler tip 600 of the type having a lower peripheral fluid orifice 601 is shown before the fabrication thereon of a multi-banded depth gauge. Such a tip is typically manufactured from surgical stainless steel alloy that is relatively hard, yet not brittle.

Referring now to FIG. 7, a first embodiment depth gauge fabrication process begins with the scaler tip 600 of FIG. 6 being subjected to a machining operation to form recesses 701 on the surface where the dark bands of the depth gauge will be located, resulting in a first in-process tip product 700. Each recess is immediately adjacent a non-recessed region 702. It should be understood that the thickness of the dark color bands to be applied to the tip may be as little as 10 to 100 microns. Hence, the drawings are for illustrative purposes only, and not necessarily drawn to scale. The recesses 701 may be formed by any available machining technique, including but not limited to grinding, masking and etching, abrasive blasting, electric discharge ablation, and laser ablation.

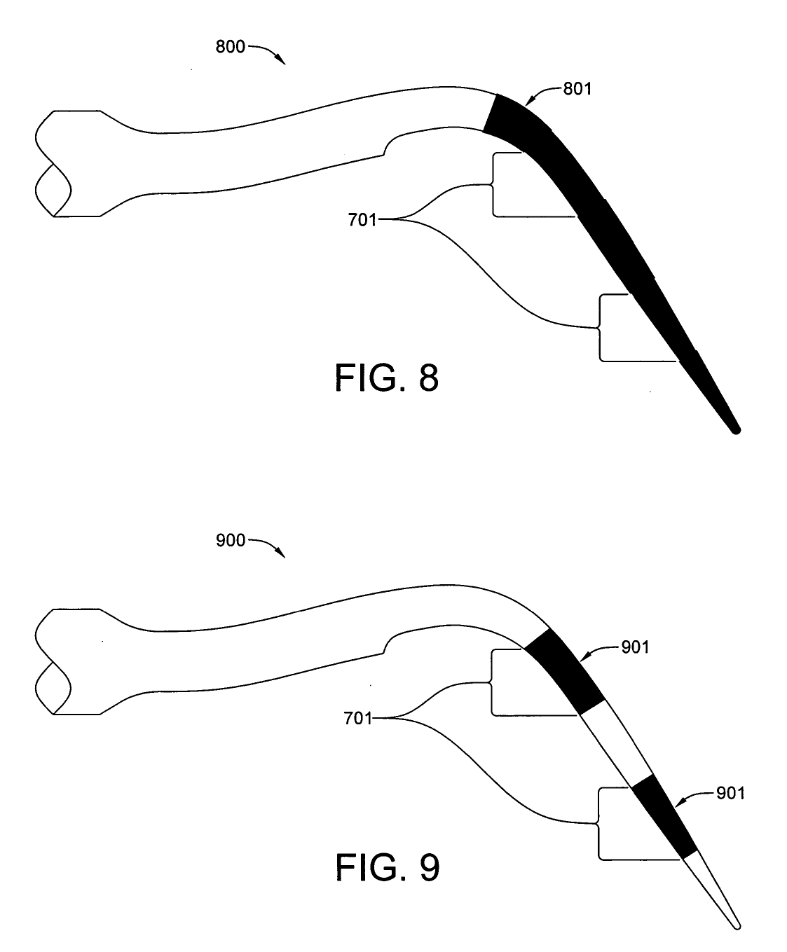

Referring now to FIG. 8, the scaler tip 700 of FIG. 7 has been subjected to a material deposition process, whereby a dark-colored wear-resistant material layer 801 has been deposited over a major portion of the tip, including over the recesses 701, resulting in a second in-process tip product 800. Preferably, the cark-colored, wear-resistant material layer 801 is deposited to a depth that is equal to the depth of the recesses 701. The dark-colored wear-resistant material layer may be any dark-colored material that is durable and compatible with the stainless steel substrate. Examples of useable materials are amorphous diamond-like carbon (black), boron carbide (black), titanium aluminum nitride (brown), zirconium nitride (gold-colored), titanium nitride (gold-colored), and other dark-colored, ultra-hard ceramic materials. The deposition is accomplished using a deposition process that is appropriate for the material being deposited and that is compatible with the stainless steel substrate. Such process include, but are not limited to chemical vapor deposition (CVD), plasma-assisted chemical vapor deposition (PCVD), physical vapor deposition (PVD), sputtering and ion plating.

Referring now to FIG. 9, the scaler tip 800 of FIG. 8 has been subjected to a post-deposition machining process that has removed portions the dark-colored, wear-resistant material layer 801 that are not within the recesses 701, with the remaining dark-colored, wear-resistant material layer bands 901 in the recesses 701 being flush with the adjacent non-recessed surfaces 902.

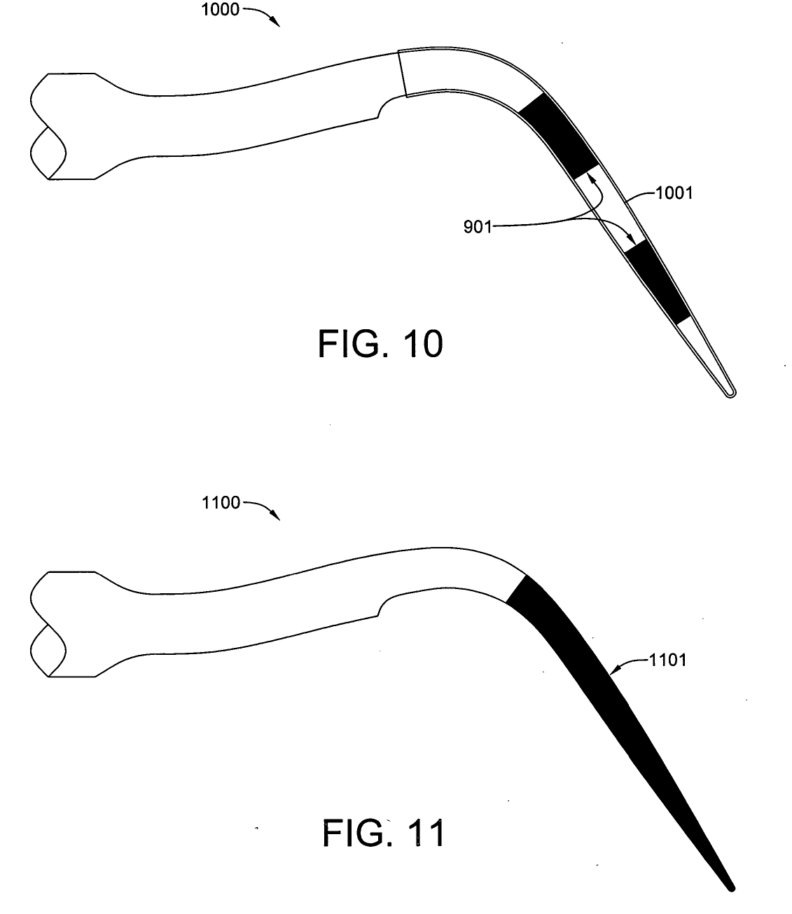

Referring-now to FIG. 10, a transparent wear-resistant material layer 1001 has been deposited over a major portion of the tip, covering both the dark-colored, wear-resistant material layer bands 901 and the adjacent non-recessed surfaces 901. The transparent wear-resistant material layer 1001 may be diamond-like carbon, aluminum oxide, zirconium oxide, or any other material layer having excellent wear-resistant properties that is compatible with the stainless steel substrate. The deposition is accomplished using a deposition process that is appropriate for the material being deposited and that is compatible with the stainless steel substrate. Such process include, but are not limited to chemical vapor deposition (CVD), plasma-assisted chemical vapor deposition (PCVD), physical vapor deposition (PVD), sputtering and ion plating. A preferred depth of the transparent wear-resistant material layer 1001 is considered to be in the range of about 25 to 100 microns.

Referring now to FIG. 11, a simpler and possibly preferred second embodiment of the depth gauge fabrication process process begins by depositing a thin dark-colored layer 1101 on a major portion of the conventional scaler tip 600 of FIG. 6, resulting in a second embodiment first in-process product 1100. The layer is sufficiently thick to provide a dark band, but thin enough that its thickness is insignificant as a percentage of tip thickness. For example, a 25-micron-thick layer is only about 0.001 of an inch thickness. A layer as thick as about five microns may be sufficient to provide a dark band, depending on the material. The dark-colored wear-resistant material layer may be any dark-colored material that is durable and compatible with the stainless steel substrate. Examples of useable materials are amorphous diamond-like carbon (black), boron carbide (black), titanium aluminum nitride (brown), zirconium nitride (gold-colored), titanium nitride (gold-colored), and other dark-colored, ultra-hard ceramic materials. The deposition is accomplished using a deposition process that is appropriate for the material being deposited and that is compatible with the stainless steel substrate. Such process include, but are not limited to chemical vapor deposition (CVD), plasma-assisted chemical vapor deposition (PCVD), physical vapor deposition (PVD), sputtering and ion plating.

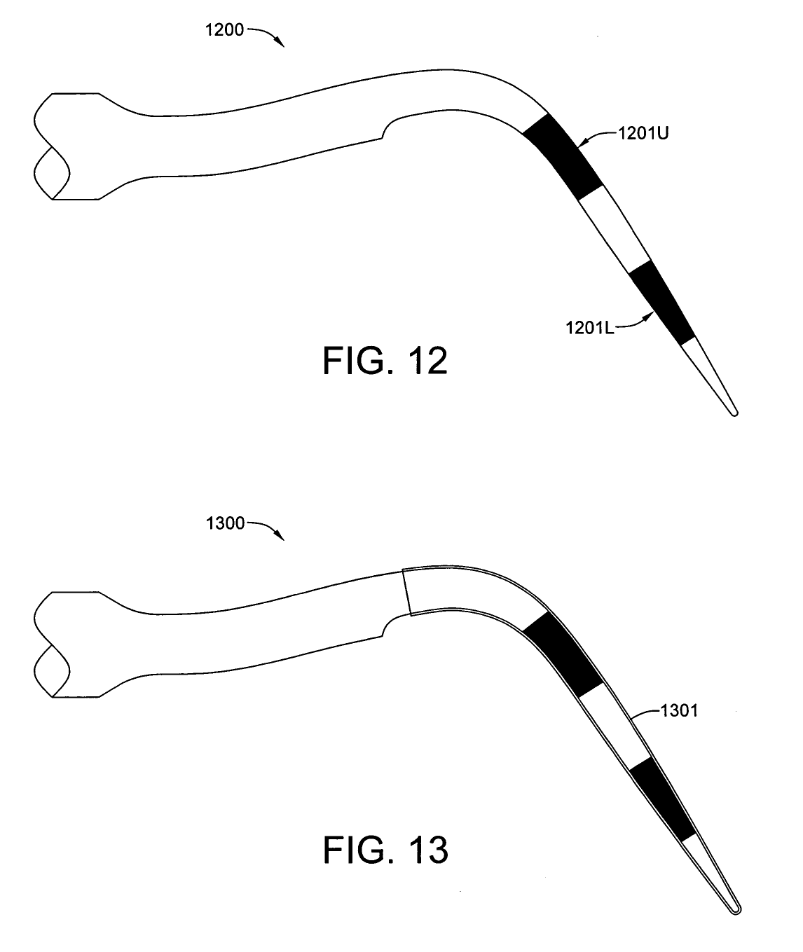

Referring now to FIG. 12, the dark-colored material layer 1101 is partially from the second embodiment first in-process product 1100 to leave a pair of cylindrical bands 1201U and 1201L. Although the resulting second embodiment second in-process product 1200 has the appearance of the desired final product, the bands are too thin to have adequate durability.

Referring now to FIG. 13, a transparent wear-resistant material layer 1301 has been deposited on a major portion of the in-process product 1200 of FIG. 12, resulting in a final product 1300 that has a durable finish that will withstand repeated cleaning operations. The transparent wear-resistant material layer 1301 may be diamond-like carbon, aluminum oxide, zirconium oxide, or any other material layer having excellent wear-resistant properties that is compatible with the stainless steel substrate. The deposition is accomplished using a deposition process that is appropriate for the material being deposited and that is compatible with the stainless steel substrate. Such process include, but are not limited to chemical vapor deposition (CVD), plasma-assisted chemical vapor deposition (PCVD), physical vapor deposition (PVD), sputtering and ion plating. A preferred depth of the transparent wear-resistant material layer 1301 is considered to be in the range of about 25 to 100 microns. The preferred coating is considered to be diamond-like carbon.

Although only a single embodiment of the present invention has been disclosed herein, it will be obvious to those having ordinary skill in the art that changes and modifications may be made thereto without departing from the scope and spirit of the invention as hereinafter may be claimed. For example, while the disclosed embodiments are designed to fit two distinct sizes of bottles, other sizes may be accommodated in a like manner.

1. An ultrasonic dental scaler device comprising:
a housing containing device electronics and controls;
a handpiece containing an actuator;
a flexible cable connecting said handpiece to said housing; and
a scaler tool attachable to said handpiece, said scaler tool having a curved tip with a multi-band depth gauge, said tip being vibrateable by said actuator.

2. The ultrasonic dental scaler device of claim 1, wherein said actuator is magnetostrictive.

3. The ultrasonic dental scaler device of claim 1, wherein said actuator is piezoelectric.

4. The ultrasonic dental scaler device of claim 1, wherein said tip is fabricated from stainless steel and said multi-band depth gauge is formed by multiple, spaced-apart, dark-colored bands, each of which is formed from a material coating deposited on the surface of the tip, said material coating having wear-resistant properties at least comparable to those of stainless steel.

5. The ultrasonic dental scaler device of claim 4, wherein said material coating is selected from the group consisting of titanium nitride, titanium carbo nitride, titanium aluminum nitride, zirconium nitride, chromium nitride, tungsten carbide, silicon carbide, chromium oxide, and chromium carbide.

6. The ultrasonic dental scaler device of claim 4, wherein the stainless steel underlying each dark-colored band has been removed an amount equal to the thickness of the material coating from which the dark-colored bands are formed.

7. The ultrasonic dental scaler device of claim 6, which further comprises a transparent wear-resistant coating overlying the entire tip.

8. The ultrasonic dental scaler device of claim 7, wherein said transparent wear-resistant coating is selected from the group consisting of diamond like carbon and aluminum oxide.

9. The ultrasonic dental scaler device of claim 4, wherein the length of each band is about 3 millimeters.
Because of the almost infinite choice of material compositions which can be sprayed, the hardness of the material can be defined exactly as per the application requirements. Typically, however, the hardness range will be at a minimum of 100 Hv for metallics up to a maximum of 1500 Hv for carbide coating
